(19) United States
(12) Patent Application Publication
(10) Pub. No.: US 2016/0065647 A1
(43) Pub. Date: Mar. 3, 2016

(54) SYSTEM AND METHOD FOR ENABLING DOWNLOADING OF FILES

(71) Applicants: Sandeep VENKATESH, Bangalore (IN); Nitin JAGADISH, Bangalore (IN); Sunil Kumar Karehalli MANJUNATH, Shimoga (IN)

(72) Inventors: Sandeep VENKATESH, Bangalore (IN); Nitin JAGADISH, Bangalore (IN); Sunil Kumar Karehalli MANJUNATH, Shimoga (IN)

(21) Appl. No.: 14/468,337

(22) Filed: Aug. 26, 2014

(51) Int. Cl. H04L 29/08

(52) U.S. Cl. CPC H04L 67/06; H04L 67/1095

(57) ABSTRACT

System and method for enabling downloading of files. The system includes an application module (102), download configuration module (106) and a database module (108). The application module (102) is configured to be associated with a device and collect data pertaining to a user's preference for downloading a file. The application module (102) communicates the preferences of a user to a download configuration module (106). The download configuration module (106) locates the files requested for the download, and thereupon splits the file into multiple parts based on the user's preferences. The multiple parts are downloaded onto one or more devices, based on the user's preferences. Upon completion of the download onto one or more devices, all the parts of the file are imported onto a device. The application module (102) is configured to combine all the parts of the file into a larger file.

### CROSS REFERENCE TO RELATED APPLICATIONS

This application claims the benefit of India non provisional utility patent application number 3783/CHE/2013 filed on Aug. 27, 2013 the entire disclosure of which is hereby incorporated by reference in its entirety as if set forth verbatim herein and relied upon for all purposes.

### BACKGROUND

### Field

In general, the subject matter relates to the field of downloading of files in a network. More particularly, but not exclusively, the subject matter relates to enabling downloading of files in a peer to peer network.

### Discussion of Related Field

Files are sought and downloaded over the internet at a large scale. There exist different methods of file downloading.

Peer to Peer networking is a popular method to enable file downloading. Peer to Peer file downloading is enabled by the technology of Peer to Peer networking. In a Peer to Peer network, the peers act both as consumers and suppliers of files. Further, in a Peer to Peer network, the peers share files amongst each other.

BitTorrent is a protocol enabling Peer to Peer file sharing. Using the BitTorrent protocol, a user desirous to share a file in a peer to peer network, can create a torrent file by providing the description of the file and thereafter, upload the said file. Other users desirous of obtaining the shared file can obtain the file from the original source by connecting to the original user. Other users in the peer to peer network start downloading the file in parts. The parts which are downloaded by the users, are made available to other users for downloading. This creates a situation wherein, multiple parts of a file are available with the peers in a network. Upon finishing of downloading of all the parts of the file, the complete file is obtained from combining all the parts of the file. The BitTorrent protocol enables uploading and downloading to and from multiple sources simultaneously.

Conventionally, when a user of the BitTorrent client is desirous of obtaining a file, the user searches for the desired file and upon finding the file, downloads the file onto one's device.

Other conventional methods of file transfer such as File Transfer Protocol (FTP) is a standard protocol for transferring files from one host to another through the internet.

There exist many conventional techniques of sharing, downloading and transferring of files over the internet. These conventional techniques enable breaking a file into multiple parts and thereupon transferring all the parts of the file to a single device. Upon completion of downloading of all the parts of the file, the parts are combined together to obtain the complete file. However, this technique is limited to a single device, wherein, all the parts of the file are downloaded onto a single device, and later combined to form the file.

A user many be desirous of breaking down the file into multiple parts, and downloading the parts of the file onto multiple devices, and upon completion combining all the parts of the file to form the complete file. Conventional techniques do not disclose techniques to breakdown a single file into multiple parts and thereupon downloading the parts onto multiple devices and upon completion of the download, combining all the parts to form a single file. Such a technique would be advantageous to users who posses multiple devices.

Therefore, in light of the foregoing discussion, a need exists for a technique for enabling downloading parts of a file onto multiple devices and upon completion, combining all the parts to form the file.

### SUMMARY

In an embodiment, a system for enabling downloading of files. The system includes an application module, a download configuration module and a database module. The application module is configured to be associated with at least one device and collect data pertaining to a user's preference for downloading a file. The application module communicates the preferences of a user to a download configuration module. The download configuration module locates the files requested for the download, and thereupon splits the file into multiple parts based on the user's preferences. The multiple parts are downloaded onto one or more devices, based on the user's preferences. Upon completion of the download of the parts of the file onto one or more devices, all the parts of the file are imported onto a device. The application module is configured to combine all the parts of the file into a larger file.

Another embodiment provides a method for enabling downloading of files. The method includes collecting data corresponding to the download preference of a user and communicating the preferences of the user relating to the download. The files are split into parts, and communicated to one or more devices. All the parts of the file are imported onto a device and combined to obtain a larger file.

### BRIEF DESCRIPTION OF DRAWINGS

Embodiments are illustrated by way of example and not limitation in the Figures of the accompanying drawings, in which like references indicate similar elements and in which:

FIG. 1 is a block diagram of an exemplary system 100 for enabling downloading parts of a file onto multiple devices and thereupon combining the parts to obtain a larger file, in accordance with an embodiment;

FIG. 2 is a flowchart of an exemplary method for downloading parts of a file onto multiple devices and thereupon combining the parts to obtain a larger file, in accordance with an embodiment; and

FIG. 3 is a flowchart of an alternate exemplary method for downloading parts of a file onto multiple devices and thereupon combining the parts to obtain a larger file, in accordance with an embodiment.

### DETAILED DESCRIPTION

### I. OVERVIEW

### II. EXEMPLARY SYSTEM

### III. EXEMPLARY METHOD 1

### IV. EXEMPLARY METHOD 2

### V. EXAMPLE 1

### VI. EXAMPLE 2

### VII. CONCLUSION

### I. OVERVIEW

Embodiments relate to technique for downloading parts of a file onto multiple devices and upon completion, combining all the parts to form the file.

In an embodiment, a system to enable downloading parts of a file onto multiple devices and upon completion, combining all the parts to obtain a larger file is provided. The system comprises of an application module, which can be installed on a user's devices. The application module is enabled to facilitate downloading of files onto the user's devices. Upon completion and importing of all the parts of the downloaded file onto the user's device, the application module is configured to combine all the parts of the file to obtain a larger file.

The application module communicates with a download configuration module. The download configuration module receives instructions pertaining to the requested download from the application module. Upon receiving the instructions, the download configuration module instructs the database module to communicate the data to multiple devices associated with the user. Further, the download configuration module is configured to monitor the files being sent to the devices and ensure that, the same part of the file is not sent to more than one device associated with the user.

The following detailed description includes references to the accompanying drawings, which form a part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiment can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### II. EXEMPLARY SYSTEM

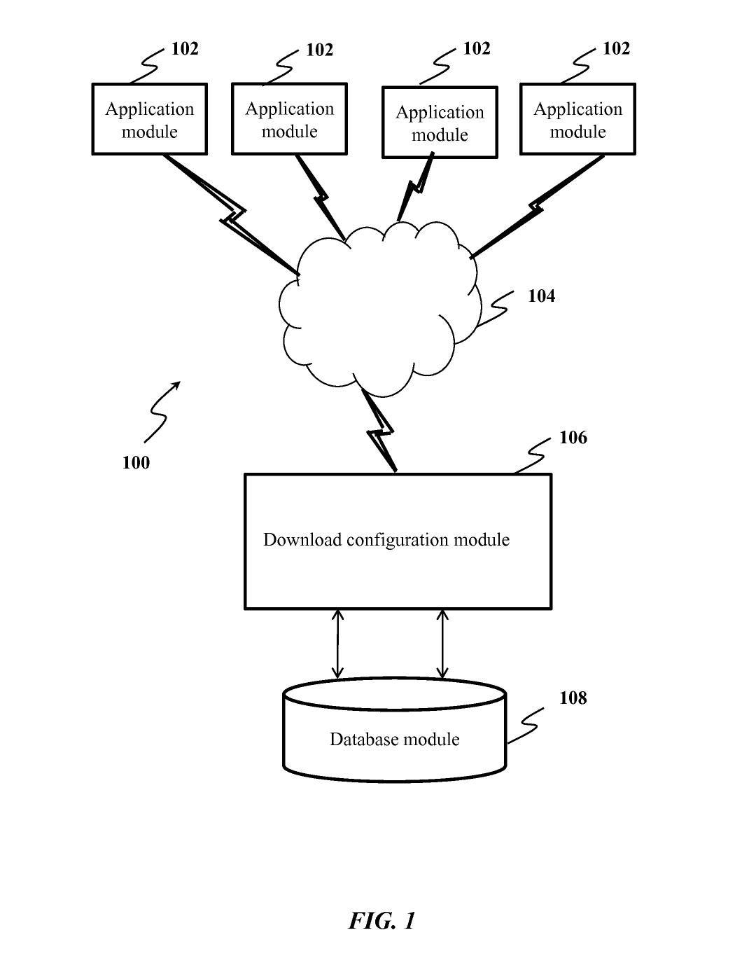

FIG. 1 is a block diagram of an exemplary system 100 for enabling downloading parts of a file onto multiple devices and thereupon combining the parts to obtain a larger file, in accordance with an embodiment. The system 100 includes an application module 102, a download configuration module 106 and a database module 108.

In an embodiment, the application module 102 is installed on a device. The device can be for example, desktop computer, laptop computer and mobile phone among others. Alternatively the application module 102 can be a web based application that can be accessed by a user through the device.

The application module 102 is configured to communicate with the download configuration module 106 through a communication network 104. The communication can occur through internet protocol.

The communication network 104 can be a wired, wireless or a combination of wired and wireless network.

In an embodiment, the application module 102 enables a user to create an account for enabling the downloading of files onto a device. The account can be created by accessing the application module 102.

In an embodiment, the application module 102 is downloaded onto the user's device and enabling communication between the application module 102 and the download configuration module 106.

The application module 102 can be configured on a plurality of devices. A user can login to the application module 102 on a plurality of devices.

In an embodiment, the application module 102 installed on a device can be configured to enable login of multiple users. The multiple users can access the application module 102 to request and configure files for downloading.

In an embodiment, the user can request the download of a file through the application module 102. The application module 102 communicates the request to the download configuration module 106. The download configuration module 106 locates the requested file on the database module 108 and instructs the database module 108 to initiate downloading of the file to the devices associated with the application module 102.

In an embodiment, when a user initiates the download through the application module 102, the user can specify the devices onto which parts of the file are to be downloaded. The user can specify the devices associated with the user. Further, the user can specify the percentage of file, which can be downloaded onto the devices selected by the user. Furthermore, the user can specify the time periods during which the download can be active on a device.

In another embodiment, the user upon consent from other users, can configure the download in such a manner that, at least a part of the file is downloaded onto the devices of other users.

In an embodiment, the application module 102 is configured to enable users to send invitations to other users to be part of the file downloading process. Upon consent from the other users, at least a part of the file can be downloaded onto devices of other users.

In another embodiment, the application module 102 enables users to form groups, which includes devices of users who are desirous to be part of the group. One or more groups can be formed to enable downloading of at least a part of the file to devices of members of the group.

In an embodiment, the download configuration module 106 is configured to receive instructions from the application module 102. The instructions pertain to the download request for the file. Upon receiving the instructions, the download configuration module 106 is configured to analyse the request, and thereupon enable the download based on the parameters chosen by the user.

The download configuration module 106 communicates with the database module 108 to locate the file desired for downloading. When the desired file is located in the database module 108, the download configuration module 106 configures the download.

In an embodiment, the parts of the file may be located on multiple database modules 108. The download configuration module 106 can configure the download based on the parameters provided by the user, such as, the devices onto which the file has to be downloaded to, the percentage of the file to be downloaded onto multiple devices and the time period during which the download has to be active on each of the device, among other parameters.

The download configuration module 106 is configured to track the parts of the file being downloaded onto the devices. The tracking of the parts of the file can be enabled by tracking the metadata of the file. This ensures that, the same parts of the file are not being downloaded onto multiple devices. The download configuration module 106 is configured to negate the communication of the same parts of the file to multiple devices. The download configuration module 106 by utilising the metadata of the parts of the file ensures that, parts of the file are not communicated to the devices more than once, when the download is initiated.

In an embodiment, the download configuration module 106 is configured to divide the file into multiple parts and thereupon initiate the downloading of the parts onto one or more devices, based on the parameters set by the user.

In an embodiment, the download configuration module 106 is configured to determine various parameters such as, whether a device is active, downloading speed of a device, available bandwidth of a device and optimum time required to complete the download, among other parameters. Based on such parameters, the download configuration module 106 can configure the downloading of files onto the devices to achieve optimum downloading of files onto the devices.

In an embodiment, when the user logs into the application module 102, the application module 102 is configured to indicate to the user, the status of downloads relating to devices associated with the user and the user's group. The status displayed to the user can pertain to progress of a download, devices onto which the download is communicated and the percentage of completion of the download, among other parameters.

Further, based on the status of the download, the application module 102 can provide the user with an option to configure the active download. The configuration of the download can pertain to initiating the download onto the device the user has logged into and modifying the parameters of the download, among other configurations.

In an embodiment, the system 100 is configured in such a manner that, when the connection to a device is lost, the configuration of the download is modified by the system 100. The configuration of the download by the system 100 is dynamic, based on real time status of the devices.

In an embodiment, the system 100 can be configured in such a manner that, when the downloading of parts of the files to be downloaded onto a device is completed, the system 100 can initiate the downloading of more parts of the file, to be downloaded onto devices which have completed the download. The configuration of the downloading of files by the system 100 can be such that, optimum downloading of files is achieved.

In an embodiment, the system 100 can configure the download in such a manner that, same parts of the file are downloaded onto multiple devices. This can be done to optimize the downloading of files.

In an embodiment, the application module 102 can be configured to ignore duplicate parts of the parts of the file, when combining all the parts of the file to obtain a larger file.

In an embodiment, when all the parts of the file are downloaded onto the devices, the parts are further imported to a single device. The application module 102 is configured to combine of all the parts of the file to form a larger file.

The importing of all the parts of the file onto a device can be enabled by techniques known in the art. For example, techniques such as importing the files through a network or using a data storage device can be utilised.

The application module 102 is configured to combine the parts of the file in its logical sequence as per the metadata of the parts of the file.

In an embodiment, the database module 108 can be located on the devices on the users. The database module 108 can be plurality of databases located on the devices of the users. This enables data being both sent and received from the devices associated with the users.

In an embodiment, the application module 102 includes the download configuration module 106. The application module 102 can be configured to carry out the functions of the download configuration module 106.

### III. EXEMPLARY METHOD 1

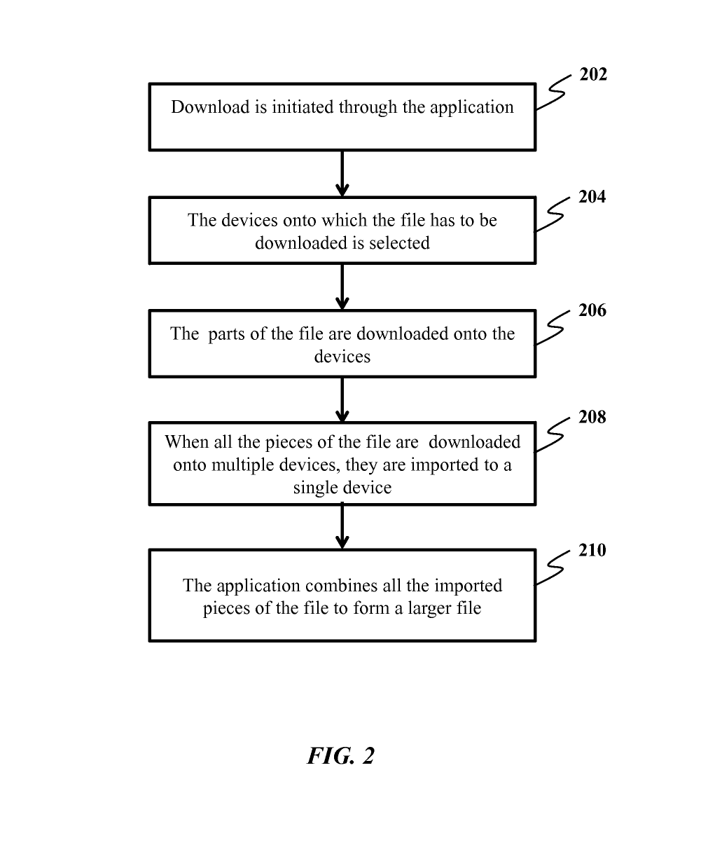

FIG. 2 is a flowchart of an exemplary method for downloading of parts of a file onto multiple devices and thereupon combining the parts to obtain the file, in accordance with an embodiment. The method includes, at step 202, initiating the download through the application module 102. Subsequently, at step 204, the user selects the devices and the percentage of the file, which are to be downloaded to the devices. At step 206, the parts of the file located on one or more databases are communicated to one or more devices, based on the user's preference. At step 208, all the parts of the file located on multiple devices are communicated to a single device. At step 210, the application module 102 combines all the parts of the file in their logical sequential order to form the larger file.

### IV. EXEMPLARY METHOD 2

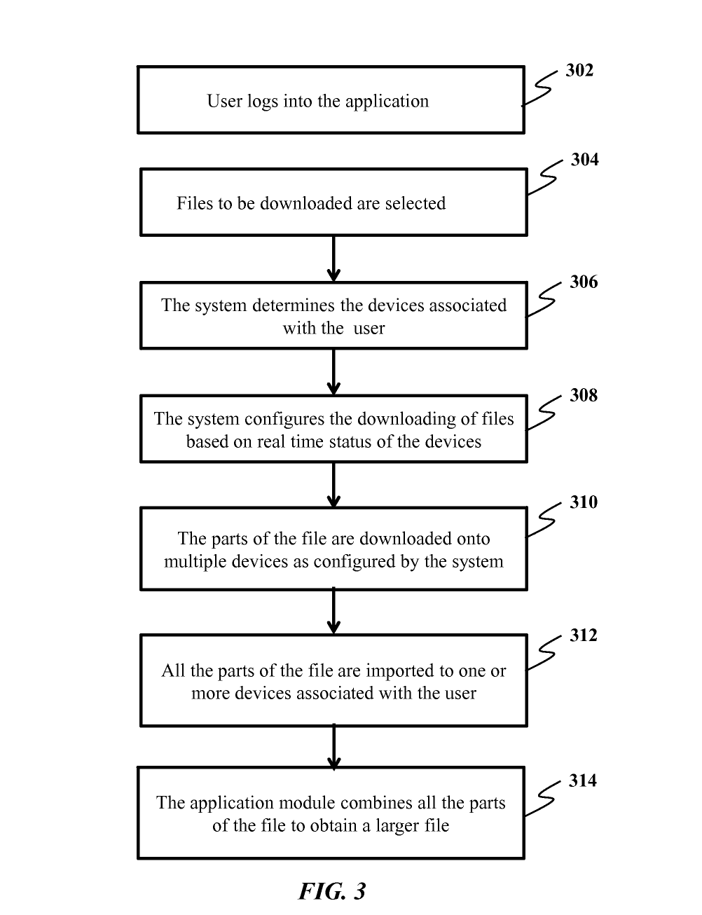

FIG. 3 is a flowchart of an alternate exemplary method for downloading parts of a file onto multiple devices and thereupon combining the parts to obtain a larger file, in accordance with an embodiment. The method includes, at step 302, the user logging into application module 102. Subsequently, at step 304, the files to be downloaded are selected by the user. At step 306, the system 100 determines the devices associated with the user. The devices associated with the user can be devices, into which the user has logged into through the application module 102 or is a part of a group. At step 308, the system 100 configures the downloading of parts of the file, based on the real time parameters of the devices associated with the user. The real time parameters can pertain to activeness of a device, speed of downloading of a device and bandwidth of a device, among other parameters. At step 310, the downloading of all the parts of the file to multiple devices is completed. At step 312 all the parts of the file are imported to one or more devices associated with the user. Subsequently at step 314 the application module 102 combines all the parts of the file in their logical sequential order to form the larger file.

### V. EXAMPLE 1

In this example a user uses the system 100 to download files onto one or more devices. The user downloads and installs the application module 102 onto his devices. Subsequently, the user creates an account and logs into the application module 102. The user specifies the devices associated with the user. The devices associated with the user, can be the user's own devices, wherein the user has logged in with his credentials or other devices, whose users have agreed to be associated with the user. When the user is desirous of downloading a file, and would prefer downloading parts of the file onto multiple devices, to save bandwidth, time and other factors, the user selects the devices onto which the parts of the file have to be downloaded. Upon initiating the download, the download configuration module 106, locates the desired file on one or more database modules 108 and thereupon initiates the download onto the devices, based on the user's preferences. The download configuration module 106 tracks the metadata of the parts of the file to ensure downloading of the file as per the user's preference. Upon completion of all the parts of the file to the devices, the user imports all the parts of the file located on multiple devices to one or more devices. The said device will now have all the parts of the desired file. The application module 102 combines all the parts of the file to form the larger file.

### VI. EXAMPLE 2

In this example a user uses the system 100 to download files onto one or more devices. The user downloads and installs the application module 102 onto his devices. Subsequently, the user creates an account and logs into the application module 102. The user specifies the devices associated with the user. The devices associated with the user, can be the user's own devices, wherein the user has logged in with his credentials or other devices, whose users have agreed to be associated with the user. When the user is desirous of downloading a file, the user initiates the download through the application module 102. Upon initiating the download, the download configuration module 106, locates the desired file on one or more database modules 108 and thereupon initiates the download onto the devices, based on the parameters determined by the download configuration module 106. The parameters determined by the download configuration module 106 can pertain to determining the activeness of a device, speed of downloading of a device and bandwidth available on a device, among other parameters. Based on such parameters, the download configuration module 106 configures the download to achieve optimum results. The download configuration module 106 tracks the metadata of the parts of the file to ensure downloading of the file as per the parameters determined by the download configuration module 106. Upon completion of all the parts of the file to the devices, the user imports all the parts of the file located on multiple devices to one or more devices. The said device will now have all the parts of the desired file. The application module 102 combines all the parts of the file to form the larger file.

### VII. CONCLUSION

In light of the above disclosure, it is evident that, the present invention has many advantages over existing technologies. Some of those advantages are mentioned below:
The system enables downloading parts of the file onto multiple devices associated with the user, and thereupon combing all the parts to form a larger file
By enabling downloading of the parts of a file onto multiple devices, the bandwidth of a device can be saved.
By enabling downloading of the parts of a file onto multiple devices, the time taken to complete a download can be reduced.
The ability of the system to enable parts of the file to be downloaded onto multiple devices is useful, when a user uses multiple devices at different time periods. This negates disrupting of the download due to the device being switched off

The embodiments enable downloading of parts of a file onto multiple devices and thereupon combining the parts to obtain the file.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A system for enabling downloading of files, the system comprising:
an application module configured to:
be associated with a device;
collect data pertaining to a user's preference for a download;
communicate instructions to a download configuration module;
receive the requested files; and
combine all the parts of the file to form a larger file.
a download configuration module configured to:
receive instructions from the application module;
locate files pertaining to a requested file;
split the file into multiple parts; and
communicate the parts of the file to one or more devices; and
a database module configured to store at least a part of the file requested for downloading.

2. The system according to claim 1, wherein the application module is configured to collect at least one of data pertaining to, devices associated with a user, file requested for download, devices onto which the file has to be downloaded, time period of downloading of the file onto one or more devices and the percentage of the file which has to be downloaded onto one or more devices.

3. The system according to claim 1, wherein the application module is configured to combine all the parts of the file to form the larger file, upon importing of all the parts of the file located on multiple devices onto a device.

4. The system according to claim 1, wherein the download configuration module is configured to receive instructions from the application module. The instructions pertaining to at least one of, devices onto which the file has to be downloaded, time period of downloading of the file onto one or more devices and the percentage of the file which has to be downloaded onto one or more devices.

5. The system according to claim 1, wherein the download configuration module is configured to split the file into one or more parts based on the instructions received from the application module.

6. The system according to claim 1, wherein the download configuration module is configured to track the file using metadata to ensure parts of the file are not downloaded onto the device more than once.

7. The system according to claim 1, wherein the download configuration module is configured to determine real time parameters relating to at least one of parameters pertaining to, active status of the device, speed of downloading of the device and available bandwidth of the device.

8. The system according to claim 7, wherein the download configuration module is configured to enable downloading of the file based on the real time parameters determined by the download configuration module.

9. The system according to claim 1, wherein the database module is located on the devices of the users.

10. A method for enabling downloading of files, the method comprising:
collecting data corresponding to the download preference of a user;
communicating the preferences of the user relating to the download;
splitting of a file into parts;
communicating parts of a file onto one or more devices;
importing all the parts of the file onto a device; and
combining all the parts of the file to obtain a larger file.

11. The method according to claim 10, wherein collecting data corresponding to the download preference of a user comprises of collecting at least one of devices associated with a user, file requested for download, devices onto which the file has to be downloaded, time period of downloading of the file onto one or more devices and the percentage of the file which has to be downloaded onto one or more devices.

12. The method according to claim 10, wherein the files are split into parts based on the download preferences of a user.

13. The method according to claim 10, wherein parts of the file are communicated to devices in a group.

14. The method according to claim 10, wherein all the parts of the file are combined to obtain a larger file, upon importing all the parts of the file onto a device.
